(19) United States
(12) Patent Application Publication
(10) Pub. No.: US 2015/0032811 A1
(43) Pub. Date: Jan. 29, 2015

(54) INTEGRATION APPARATUS AND INTEGRATION METHOD THEREOF FOR INTEGRATING CALENDAR SYSTEM AND CLOUD STORAGE SYSTEM

(71) Applicant: Institute For Information Industry, Taipei (TW)

(72) Inventors: Yen-Hung KUO, Taipei City (TW); Yu-Lin JENG, Tainan City (TW)

(73) Assignee: Institute For Information Industry, Taipei (TW)

(21) Appl. No.: 13/953,442

(22) Filed: Jul. 29, 2013

(51) Int. Cl. H04L 29/08

(52) U.S. Cl. CPC H04L 67/10
USPC 709/204

(57) ABSTRACT

An integration apparatus and an integration method, an integration program thereof for integrating a calendar system and a cloud storage system are provided. The integration apparatus includes a network interface, a storage medium and a processor. The network interface is connected to a network. The storage medium stores an integration program. The processor is electrically connected to the network interface and the storage medium, and it is configured to run the integration program to execute the integration method to integrate the calendar and cloud storage systems together.

### FIELD

The present invention relates to an integration apparatus and an integration method for integrating a calendar system and a cloud storage system. More particularly, the integration apparatus of the present invention links multiple users' calendars and cloud storage mediums together based on a specific event.

### BACKGROUND

Online services, such as calendar services, cloud storage services, messaging services etc., have become an important part of our daily lives and working environment. For example, participants of a meeting use online calendars for arranging their meeting schedules, create files for a meeting and store the created files in their own cloud storage spaces. However, these relevant files are usually revised, resent and reshared many times via a messaging service (i.e. email services) by participants before, in, and after the meeting. Over time, it may become difficult to find a specific file related to the meeting. Consequently, redundant file copies occupy participants' cloud storage spaces, however not all participants have the up-to-date files when the meeting started, and most participants are difficult to relocate the files in their cloud storage spaces after the meeting.

Accordingly, efforts still have to be made in this field to provide a mechanism, which can effectively resolve the file management issue when sharing files around calendar-events.

### SUMMARY

An objective of the present invention is to provide a mechanism which can effectively integrate a conventional online calendar system and a conventional cloud storage system to resolve the file management issue when sharing files around calendar-events.

To achieve the aforesaid objective, certain embodiments of the present invention disclose an integration apparatus for integrating a calendar system and a cloud storage system. The integration apparatus comprises a network interface, a storage medium, and a processor. The network interface is connected to a network. The storage medium is configured to store an integration program. The processor is electrically connected to the network interface and the storage medium, and is configured to run the integration program to execute the following steps: (a) receiving an event message via the network interface, initiated by a user device, sent from the calendar system, including a plurality of event participant's account addresses and an event description; (b) parsing the received event message; (c) extracting the event participants' account addresses from the event message; (d) accessing the cloud storage system via the network interface to match the event participants' account addresses with a cloud storage account database of the cloud storage system, obtain a plurality of cloud storage accounts matched the event participants' account addresses, create a share folder in the cloud storage system and share the share folder to the matched cloud storage accounts; and (e) accessing the calendar system via the network interface to update the event description by adding a share link of the share folder of the cloud storage system.

In addition, to achieve the aforesaid objective, certain embodiments of the present invention further disclose an integration method for use in an integration apparatus for integrating a calendar system and a cloud storage system. The integration apparatus comprises a network interface, a storage medium, and a processor. The network interface is connected to a network. The storage medium is configured to store an integration program for the integration method. The processor is electrically connected to the network interface and the storage medium, and is configured to run the integration program to execute the integration method.

In one example embodiment, the integration method comprises the following steps: (a) receiving an event message via the network interface, initiated by a user device, sent from the calendar system, including a plurality of event participants' account addresses and an event description; (b) parsing the event message; (c) extracting the event participants' account addresses from the event message; (d) accessing the cloud storage system via the network interface to match the event participants' account addresses with a cloud storage account database of the cloud storage system, obtain a plurality of cloud storage accounts matched the event participants' account addresses, create a share folder in the cloud storage system and share the share folder to the matched cloud storage accounts; and (e) accessing the calendar system via the network interface to update the event description by adding a share link of the share folder of the cloud storage system.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic view illustrating the connectional relationships among an integration apparatus 11, a calendar server 13 and a cloud storage server 15 according to the first embodiment of the present invention;

FIG. 2 is a schematic view of an integration apparatus 11 of the present invention;

FIG. 3 is a schematic view illustrating the connectional relationships among an integration apparatus 11 and a service-providing server 31 according to the second embodiment of the present invention; and

FIG. 4 is a flowchart diagram of an integration method according to the third embodiment of the present invention.

### DETAILED DESCRIPTION

In the following description, this invention will be explained with reference to example embodiments thereof. However, the description of these example embodiments is only for purposes of illustration rather than limitations. It should be appreciated that in the following example embodiments and the attached drawings, the elements not related directly to this invention are omitted from depiction and dimensional relationships among the individual elements in the attached drawings are illustrated only for ease of understanding, and not limitation.

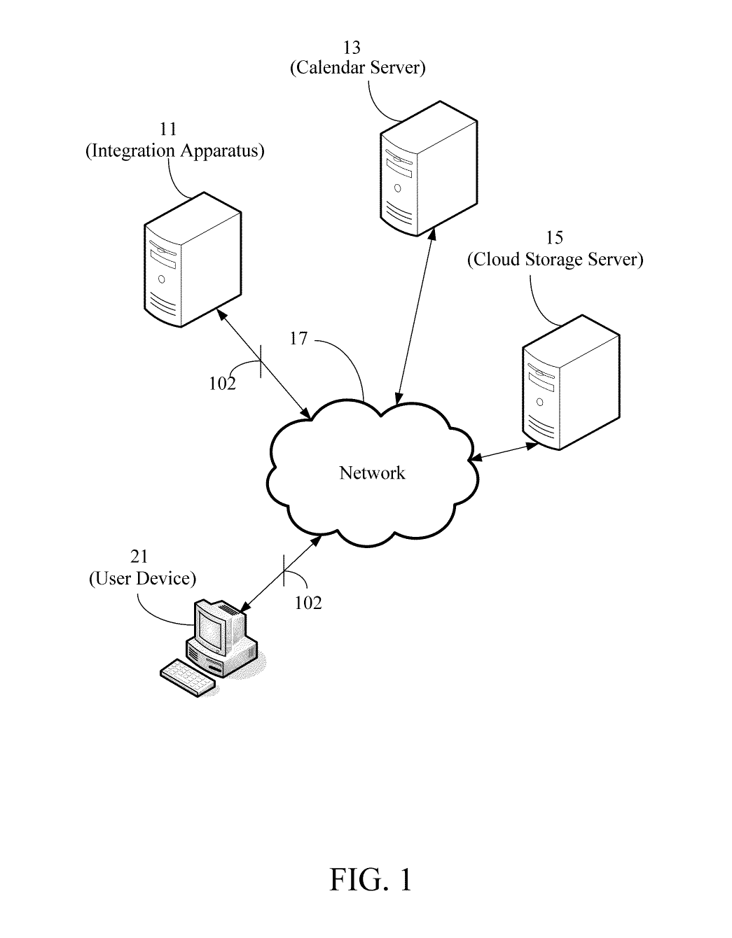

The first embodiment of this invention is depicted in FIG. 1, which is a schematic view illustrating the connectional relationships among an integration apparatus 11, a calendar server 13 and a cloud storage server 15. The integration apparatus 11 of the present invention can access a calendar system executed in the calendar server 13 and a cloud storage system executed in the cloud storage server 15 through the network 17. The network 17 is constituted by the Internet, telecommunication network, personal network or any combination thereof.

The calendar server 13 runs a calendar system (e.g. Google calendar) for users arranging their schedules. The cloud storage server 15 runs a cloud storage system (e.g. Google drive or “Dropbox) for users storing and sharing their files. In this embodiment, the integration apparatus 11 runs an integration program for an integration method invented in this invention to parse event messages 102 (e.g. event messages can be event invitation mails containing event participants' email addresses and event descriptions) sent from the calendar system executed in the calendar server 13 and do proper interactions with calendar system executed in the calendar server 13 and cloud storage system executed in the cloud storage server 15 according to contents of received event messages 102 through the network 17.

When a user wants to invite other people to an event (e.g. a meeting), he or she can use his or her user device 21 to access the calendar system executed in the calendar server 13 to add a corresponding event to the calendar system executed in the calendar server 13 and to send an event message 102 to people that he or she wants to invite to the event. The event message 102 includes a plurality of event participants' account addresses and an event description, which may contain the time, place, or any relevant information to the event. Once participants of the event receive the event message 102 and accept the event invitation, the event will be added to their personal calendars in the calendar system executed in the calendar server 13. It shall be noted that the present invention can be applied to any case in which there is two or more participants including the sender and the recipients; however, the number of the participants is not intended to limit the scope of the present invention.

Taking email addresses as event participants' account addresses for example, the event message 102 is an email which contains the email address of the integration apparatus 11 and the email addresses of the participants in the event as well. Except for the email address of the sender, other email addresses are the destination of the event message 102. After receiving the event message 102, the integration apparatus 11 parses the event message 102 and extracts the event participants' account addresses (i.e. the email addresses of the participants) from the event message 102. Afterwards, the integration apparatus 11 accesses the cloud storage system to match the event participants' account addresses with a cloud storage account database of the cloud storage system executed in the cloud storage server 15 and to obtain a plurality of matched cloud storage accounts from the cloud storage account database. The present invention assumes that cloud storage accounts stored in the cloud storage account database have at least one attribute which can match the event participants' addresses (identities) used in the event message 102 (e.g. an email address).

Once the related cloud storage accounts are obtained, the integration apparatus 11 creates a share folder in the cloud storage system executed in the cloud storage server 15 and shares the created share folder to the matched cloud storage accounts in the cloud storage system executed in the cloud storage server 15. Finally, the integration apparatus 11 accesses the calendar system executed in the calendar server 13 through the network 17 to update the event description by adding a share link of the share folder in the cloud storage system executed in the cloud storage server 15. Afterwards, event participants will have the created share folder in their own cloud storage spaces in the cloud storage system executed in the cloud storage server 15 automatically, and they are able to access the event related files through either their own cloud storage spaces in the cloud storage system executed in the cloud storage server 15 or the event in their own personal calendar in the calendar system executed in the calendar server 13.

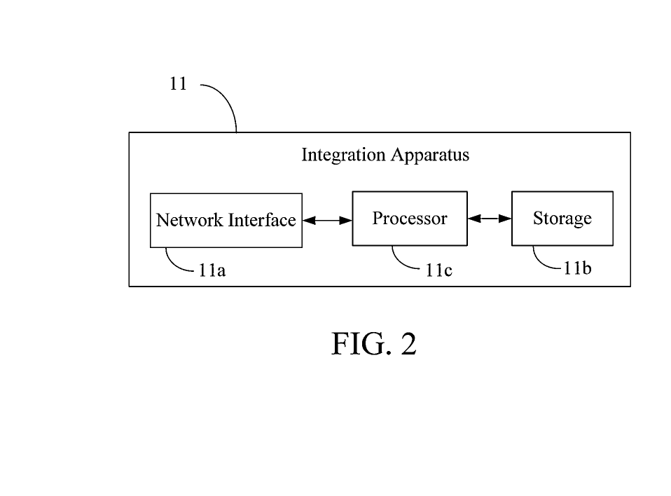

According to FIG. 2, the integration apparatus 11 of the present invention comprises a network interface 11a, a storage medium 11b and a processor 11c. The network interface 11a is connected to the network 17 for dealing with message communications from/to the network to/from the integration apparatus. The storage medium may be a tangible machine-readable medium for providing the integration apparatus with a permanent storage, such as a read only memory (ROM), a flash memory, a hard disk, or any other storage media with the same function and well known to those skilled in the art.

The processor 11c is electrically connected to the network interface 11a and the storage medium 11b. The processor 11c runs the integration program for the integration method stored in the storage medium 11b. The processor 11c receives the event message 102 via the network interface 11a, initiated by the user device 21, from the calendar system executed in the calendar server 13. The processor 11c parses the event message 102 and extracts the account addresses from the event message 102. The processor 11c accesses the cloud storage system executed in the cloud storage server 15 via the network interface 11a to match the account addresses with a cloud storage account database of the cloud storage system executed in the cloud storage server 15, obtain the cloud storage accounts matched the account addresses, create the share folder in the cloud storage system executed in the cloud storage system 15 and share the share folder to the matched cloud storage accounts in the cloud storage system executed in the cloud storage system 15. The processor 11c accesses the calendar system executed in the calendar server 13 via the network interface 11a to update the event description by adding the share link of the share folder.

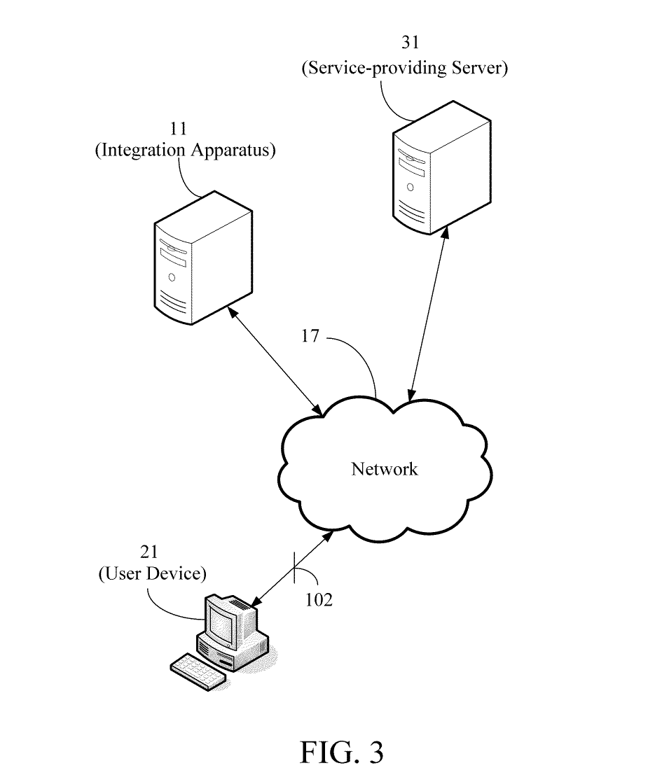

The second embodiment of the present invention is depicted in FIG. 3, which is a schematic view illustrating the connectional relationships among the integration apparatus 11 and a service-providing server 31. In this embodiment, the calendar system and the cloud storage system are run in the service-providing server 31. The integration apparatus 11 of the present invention can access the service-providing server 31 to achieve operations described in the first embodiment, and thus, will not be further described herein

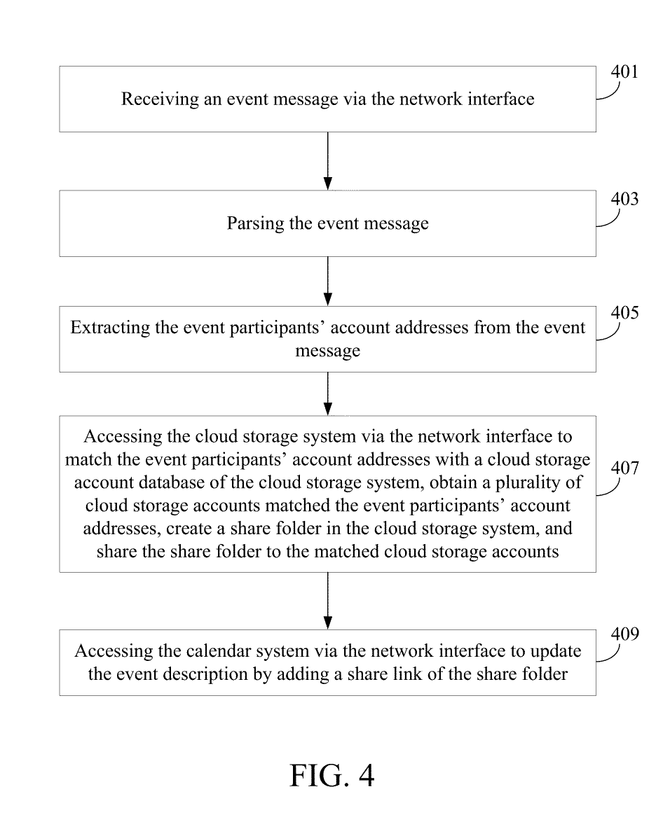

The third embodiment of the present invention is an integration method for an integration apparatus (e.g. the integration apparatus 11 described in the previous embodiments); a flowchart of which is depicted in FIG. 4. The integration apparatus comprises a network interface connected to a network, a storage medium and a processor electrically connected to the network interface and the storage medium. The storage medium stores an integration program for the integration method. The integration program is a computer executable program and it is run by the processor in the integration apparatus 11 to perform processes depicted in FIG. 4.

Firstly, step 401 is executed to enable the processor to receive an event message via the network interface, initiated by a user device, from a calendar system. The event message includes a plurality of event participants' account addresses and an event description. Step 403 is executed to enable the processor to parse the received event message. Then, step 405 is executed to enable the processor to extract the event participants' account addresses from the event message.

Following that, step 407 is executed to enable the processor to access the cloud storage system via the network interface to match the event participants' account addresses with a cloud storage account database of the cloud storage system, obtain a plurality of cloud storage accounts matched the event participants' account addresses, create a share folder in the cloud storage system, and share the share folder to the matched cloud storage accounts in the cloud storage system. Finally, step 409 is executed to enable the processor to access the calendar system via the network interface to update the event description by adding the share link of the share folder in the cloud storage system.

In addition to the aforesaid steps, the integration method of this embodiment can also execute all the operations set forth in the first and second embodiments and accomplish all the corresponding functions. The method in which the integration method of this embodiment executes these operations and accomplishes these functions can be readily appreciated by those of ordinary skill in the art based on the explanation of the first and second embodiments, and thus, will not be further described herein.

According to the above descriptions, the present invention can link the event in event participants' personal calendars in the calendar system and the share folder created in participants' cloud storage spaces in the cloud storage system. Accordingly, this invention allows event participants to upload event related files into the share folder to share event related files among participants, as well as allows event participants to access the event related files by through either the share folder in their personal cloud storage spaces or the share link in the event of their personal calendars. Therefore, the present invention can effectively integrate the conventional online calendar system and conventional cloud storage system to resolve the file management issue of file sharing around calendar-events.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An integration apparatus for integrating a calendar system and a cloud storage system, comprising:
a network interface connected to a network;
a storage medium, being configured to store an integration program; and
a processor electrically connected to the network interface and the storage medium, being configured to run the integration program to execute the following steps:
(a) receiving an event message via the network interface, initiated by a user device, sent from a calendar system, including a plurality of event participants' account addresses and an event description;
(b) parsing the event message;
(c) extracting the event participants' account addresses from the event message;
(d) accessing the cloud storage system via the network interface to match the event participants' account addresses with a cloud storage account database of the cloud storage system, obtain a plurality of cloud storage accounts matched the event participants' account addresses, create a share folder in the cloud storage system, and share the share folder to the matched cloud storage accounts; and
(e) accessing the calendar system via the network interface to update the event description by adding a share link of the share folder.

2. The integration apparatus as claimed in claim 1, wherein the event participants' account addresses are email addresses.

3. The integration apparatus as claimed in claim 1, wherein the network interface is remotely connected to a calendar server and a cloud storage server, the calendar system is located on the calendar server, and the cloud storage system is located on the cloud storage server.

4. The integration apparatus as claimed in claim 1, wherein the network interface is remotely connected to a service-providing server, and the calendar system and the cloud storage system are located on the service-providing server.

5. An integration method for use in an integration apparatus for integrating a calendar system and a cloud storage system, the integration apparatus comprising a network interface, a storage medium and a processor, the network interface being connected to a network, the storage medium storing an integration program for the integration method, the processor being electrically connected to the network interface and the storage medium and running the integration program to execute the integration method, the integration method comprising the steps:
(a) receiving an event message via the network interface, initiated by a user device, from the calendar system, including a plurality of event participants' account addresses and an event description;
(b) parsing the event message;
(c) extracting the event participants' account addresses from the event message;
(d) accessing the cloud storage system via the network interface to match the event participants' account addresses with a cloud storage account database of the cloud storage system, obtain a plurality of cloud storage accounts matched the event participants' account addresses, create a share folder in the cloud storage system, and share the share folder to the matched cloud storage accounts; and
(e) accessing the calendar system via the network interface to update the event description by adding a share link of the share folder.

6. The integration method as claimed in claim 5, wherein the event participants' account addresses are email addresses.

7. The integration method as claimed in claim 5, wherein the network interface is remotely connected to a calendar server and a cloud storage server, the calendar system is located on the calendar server, and the cloud storage system is located on the cloud storage server.

8. The integration method as claimed in claim 5, wherein the network interface is remotely connected to a service-providing server, and the calendar system and the cloud storage system are located on the service-providing server.
